(19) United States
(12) Patent Application Publication
(10) Pub. No.: US 2024/0194374 A1
(43) Pub. Date: Jun. 13, 2024

(54) METHOD OF MANUFACTURING A SUBMARINE POWER CABLE

(71) Applicant: NKT HV Cables AB, Lyckeby (SE)

(72) Inventor: Sonny Långström, Karlskrona (SE)

(21) Appl. No.: 18/531,107

(22) Filed: Dec. 6, 2023

(30) Foreign Application Priority Data
Dec. 13, 2022 (EP) 22213133.6

(51) Int. Cl. H01B 7/14; H01B 7/20; H01B 7/282; H01B 13/26

(52) U.S. Cl. CPC H01B 7/14; H01B 7/207; H01B 7/2825; H01B 13/264

(57) ABSTRACT

A method of manufacturing a submarine power cable, including: a) providing an insulation system around a conductor, the insulation system including an inner semiconducting layer arranged around the conductor, an insulation layer arranged around the inner semiconducting layer, and an outer semiconducting layer arranged around the insulation layer, b) arranging a metal sheath around the insulation system, and c) welding opposing edges of the metal sheath longitudinally by autogenous welding to form a metallic water-blocking layer around the insulation system, wherein the metal sheath consists of a copper material comprising at least 99 wt. % copper and at most 0.1 wt. % oxygen, or wherein the metal sheath consists of a stainless steel which has a chromium equivalent in a range of 16-25 and a nickel equivalent in a range of 11-22 according to a Schaeffler-DeLong constitutional diagram for which the chromium equivalent is calculated according to the formula % Cr+% Mo+1.5×% Si+0.5×% Nb and the nickel equivalent is calculated according to the formula % Ni+0.5×% Mn+30×(% C+% N).

### TECHNICAL FIELD

The present disclosure generally relates to submarine power cables.

### BACKGROUND

Submarine power cables have traditionally had a lead sheath which acts as a radial water barrier protecting the insulation system.

There is a trend towards a lead-free radial water barrier design. There have been proposals of water barriers of for example copper, various copper alloys, aluminium, and stainless steel.

Typically, the water barrier is made by first longitudinally wrapping a metal tape around the insulation system and then welding opposite edges of the metal tape in the longitudinal direction of the cable. There are however various challenges with the welding process, which may impact the quality of the water barrier.

With regards to various water barrier materials, copper, for example, can only dissolve a very low amount of oxygen. The oxygen not dissolved in the copper matrix is bound as cuprous oxide dispersed in the copper matrix. When welding oxygen containing copper, hydrogen from the atmosphere may diffuse into the weld melt and react with the cuprous oxide, forming water vapour. This leads to a considerable volume expansion. Small vapour bubbles form at mainly the grain boundaries and risk to cause cracking along the grain boundaries. There is thus a risk that water and/or humidity diffuses through the weld and further into the insulation system, which could damage the cable for example due to water-treeing in the insulation system.

Not all stainless steels are suitable to be used as a metallic sheath for a submarine power cable. For example, some stainless steels that are welded autogenously will have weld defects such as cracks that are formed due to an unfavourable solidification process, phase transformations, and/or give an unfavourable weld microstructure which is not capable to handle the strain that it will be subjected to in a submarine power cable application.

### SUMMARY

In view of the above, an object of the present disclosure is to provide a method of manufacturing a submarine power cable which solves or at least mitigates the problems of the prior art.

There is hence according to a first aspect of the present disclosure provided a method of manufacturing a submarine power cable, comprising: a) providing an insulation system around a conductor, the insulation system including an inner semiconducting layer arranged around the conductor, an insulation layer arranged around the inner semiconducting layer, and an outer semiconducting layer arranged around the insulation layer, b) arranging a metal sheath around the insulation system, and c) welding opposing edges of the metal sheath longitudinally by autogenous welding to form a metallic water-blocking layer around the insulation system, wherein the metal sheath consists of a copper material comprising at least 99 wt. % copper and at most 0.1 wt. % oxygen, or wherein the metal sheath consists of a stainless steel which has a chromium equivalent in a range of 16-25 and a nickel equivalent in a range of 11-22 according to a Schaeffler-DeLong constitutional diagram for which the chromium equivalent is calculated according to the formula % Cr+% Mo+1.5×% Si+0.5×% Nb and the nickel equivalent is calculated according to the formula % Ni+0.5×% Mn+30×(% C+% N).

By using a copper material with very low oxygen content, the risk of hydrogen embrittlement in the weld and the Heat Affected Zone (HAZ) is reduced. Further, by making the weld by autogenous welding no filler material, which typically contains deoxidizers, is required. Only the copper material itself is melted. This ensures a high-quality weld.

Stainless steels within these ranges do not undergo any hardening process during solidification of the weld, and furthermore, they also solidify not fully austenitic but with a delta ferrite phase which is very beneficial for avoiding solidification cracks.

With autogenous welding is meant welding the opposing edges of the metal sheath by melting the edges and joining the edges without the use of any filler/welding material.

By using autogenous welding, the weld geometry will be very smooth, without excessive weld top or root dimensions, which is beneficial for the water-blocking layer which should have an essentially circular symmetrical geometry in cross-section of the submarine power cable. Further, the risk of critical weld deviations in the weld geometry is reduced. Adding welding material could cause intermittent feed into the weld pool, with this risk increasing when the welding is carried out continuously for a long section of submarine power cable. There is further no risk of weld disturbances caused by contaminated or bad welding wire or risk of broken wire feeder lines which could cause weld interruptions and disturbances. Using autogenous welding also facilitates handling of the metallic water-blocking layer, for example in case the metallic water-blocking layer is subjected to a corrugation process and/or if it subjected to a diameter reduction by means of rollers and/or dies.

The submarine power cable may be an AC submarine power cable or a DC submarine power cable.

The submarine power cable may be a medium voltage or a high voltage submarine power cable. With high voltage is meant a nominal voltage of the submarine power cable of 30 kV or more.

According to one embodiment after step c) has been performed the stainless steel has a Ferrite Number in a range of 1-15 in the weld seam. The stainless steel weld metal, i.e., the weld seam formed by the autogenous welding, thus has a Ferrite Number in a range of 1-15. The stainless steels within the boundary formed by the Ferrite Number in combination with the above-defined chromium and nickel equivalent ranges according to the Schaeffler-DeLong constitutional diagram are therefore never fully austenitic stainless steels when welded autogenously. Austenitic stainless steels which give a fully austenitic microstructure are more difficult to weld autogenously since the risk of solidification cracking increase dramatically.

According to one embodiment step c) is performed using a protective shielding gas. Using a protective shielding gas, such as one or more inert gasses, the risk of oxidisation of the weld seam is eliminated.

According to one embodiment the copper material comprises at most 0.06 wt. % oxygen, such as at most 0.05 wt. %, such as at most 0.04 wt. % oxygen, such as at most 0.004 wt. %, such as at most 0.001 wt. % oxygen. The less oxygen the copper material contains, the smaller the risk of hydrogen embrittlement of the weld seam as a result of the autogenous welding process.

The copper material may comprise oxygen in a range of less than 0.001 wt. % to 0.06 wt. %, such as less than 0.001 wt. % to 0.004 wt. %.

According to one embodiment the copper material comprises at least 99.9 wt. % copper.

According to one embodiment the copper material is Cu-DHP, Cu-ETP, or Cu-OF. These copper materials are not intentionally alloyed coppers and are one-phase metals which do not undergo any hardening process during solidification, which is the most beneficial for the weld quality.

Cu-DHP, which is a copper material deoxidised with phosphorous is especially suitable when welding copper autogenously, because phosphorous decreases the heat conductivity allowing a lower weld heat input to be used, resulting in a better melting behaviour. Another advantage is that the residual phosphorous amount left in the copper compete with hydrogen and its strong affinity to oxygen leads to formation of oxygen containing phosphates of any oxygen left in the material.

According to one embodiment a sample of the copper material shows no evidence of cracking after a hydrogen embrittlement test carried out according to section 8.2.2 of EN 1976, and EN ISO 2626. The hydrogen embrittlement test is thus that of section 8.2.2 of EN 1976, which refers to EN ISO 2626 for test specifics. Verification of embrittlement can be done in accordance with the tests described in EN ISO 2626, e.g., back-and-forth bending and microscopic examination.

According to one embodiment the stainless steel is an austenitic stainless steel type selected from one of type 304, 304L, 316, or 316L, 316Ti, 316Cb 321, or 347 as defined by ASTM A240/A240M-22b or equivalents thereof according to EN 10088-1:2005.

According to one embodiment the autogenous welding is one of laser, tungsten inert gas, TIG, or plasma autogenous welding.

According to one embodiment the metal sheath has a thickness in a range of 0.4-2 mm. Autogenous welding is specifically advantageous in this thickness range as compared to using a welding filler material because adding a filler material increases the risk of weld abnormalities.

According to one embodiment the submarine power cable is a dynamic submarine power cable.

According to one embodiment the submarine power cable is a static submarine power cable.

According to one embodiment step c) is carried out while the conductor with the insulation system around it moves longitudinally, and wherein step c) is performed for a continuous length of the conductor and the insulation system which is at least 5 km, such as at least 10 km.

According to one embodiment the submarine power cable is a high voltage power cable.

There is according to a second aspect provided a submarine power cable obtainable by the method of the first aspect.

Generally, all terms used in the claims are to be interpreted according to their ordinary meaning in the technical field, unless explicitly defined otherwise herein. All references to “a/an/the element, apparatus, component, means”, etc. are to be interpreted openly as referring to at least one instance of the element, apparatus, component, means, etc., unless explicitly stated otherwise.

### BRIEF DESCRIPTION OF THE DRAWINGS

The specific embodiments of the inventive concept will now be described, by way of example, with reference to the accompanying drawings, in which:

FIG. 1 schematically shows a cross-sectional view of an example of a submarine power cable; and

FIG. 2 schematically shows a perspective view of autogenous welding of metal sheath arranged around an insulation system; and

FIG. 3 shows a method of manufacturing a submarine power cable.

### DETAILED DESCRIPTION

The inventive concept will now be described more fully hereinafter with reference to the accompanying drawings, in which exemplifying embodiments are shown. The inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description.

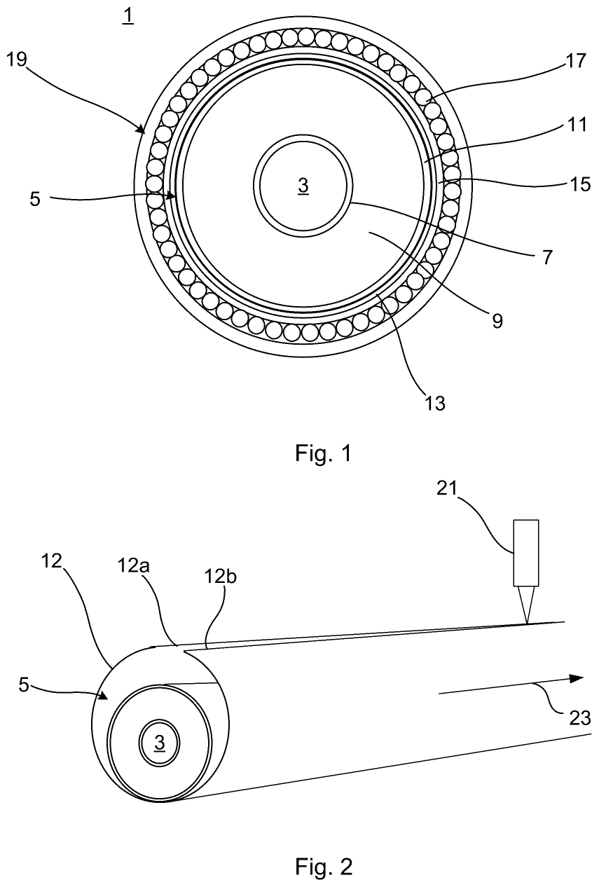

FIG. 1 shows a cross section of an example of a submarine power cable 1. Although the exemplified submarine power cable 1 depicts a single core submarine power cable, the submarine power cable 1 could alternatively be a multi-core submarine power cable.

The submarine power cable 1 may be an AC submarine power cable or a DC submarine power cable.

The submarine power cable 1 comprises a conductor 3, and an insulation system 5 arranged around the conductor 3.

The insulation system 5 comprises an inner semiconducting layer 7 which is arranged around the conductor 3, an insulation layer 9 arranged around the inner semiconducting layer 7, and an outer semiconducting layer 11 arranged around the insulation layer 9.

The insulation system 5 may be an extruded insulation system or a paper-based insulation system which is impregnated with insulating fluid such as an oil.

In case the insulation system 5 is an extruded insulation system, the insulation system comprises a polymer material such as polyethylene, cross-linked polyethylene, polypropylene, ethylene propylene rubber (EPR) or ethylene propylene diene monomer rubber (EPDM).

The submarine power cable 1 also comprises a metallic water-blocking layer 13. The metallic water-blocking layer 13 has a longitudinal weld seam which has been formed without any filler material. The metallic water-blocking layer 13 has thus been autogenously welded.

The metallic water-blocking layer 13 is made of a copper material comprising at least 99 wt. % copper and at most 0.1 wt. % oxygen, or of a stainless steel which has a chromium equivalent in a range of 16-25 and a nickel equivalent in a range of 11-22 according to a Schaeffler-DeLong constitutional diagram for which the chromium equivalent is calculated according to the formula % Cr+% Mo+1.5×% Si+0.5×% Nb and the nickel equivalent is calculated according to the formula % Ni+0.5×% Mn+30×(% C+% N).

The metallic water-blocking layer 13 may have a thickness in a range of 0.4-2 mm.

The copper material may comprise at most 0.06 wt. % oxygen, such as at most 0.05 wt. %, such as at most 0.04 wt. % oxygen, such as at most 0.004 wt. %, such as at most 0.001 wt. % oxygen.

The copper material may comprise at least 99.9 wt. % copper.

The copper material may for example be Cu-DHP, Cu-ETP, or Cu—OF.

A sample of the copper material may according to one example show no evidence of cracking after a hydrogen embrittlement test carried out according to section 8.2.2 of EN 1976, and EN ISO 2626.

The stainless steel may in the weld seam have a Ferrite Number in a range of 1-15.

The stainless steel may be an austenitic stainless steel type selected from one of type 304, 304L, 316, 316L, 316Ti, 316Cb 321, or 347 as defined by ASTM A240/A240M-22b or equivalents thereof according to EN 10088-1:2005.

The submarine power cable 1 comprises a polymer layer 15 arranged around the metallic water-blocking layer 13. The polymer layer 15 may be extruded onto the metallic water-blocking layer 13. The polymer layer 15 may according to one example be bonded to the outer surface of the metallic water-blocking layer 13 by means of an adhesive such as a hot melt adhesive.

The submarine power cable 1 may comprise an armour layer comprising a plurality of armour elements 17 laid helically around the polymer layer 15 in one or more layers.

The submarine power cable 1 may have an outer layer 19 which may be an outer sheath composed of a polymer material, or an outer serving composed of a plurality of helically wound polymeric elements.

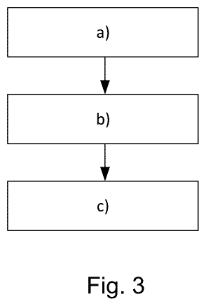

A method of manufacturing a submarine power cable such as the submarine power cable 1 will now be described with reference to FIGS. 2 and 3.

In a step a) the insulation system 5 is provided around the conductor 3.

The insulation system 5 may for example be extruded onto the conductor 3 such as by means of a triple extrusion. Alternatively, the insulation system 5 may be formed by winding semiconducting and insulating paper tapes to form the inner semiconducting layer 7, the insulation layer 9, and the outer semiconducting layer 11. In this case, the paper tapes wound around the conductor 3 are impregnated before step b).

In a step b) a metal sheath 12 is arranged around the insulation system 5. The metal sheath 12 may be a tape that is longitudinally wrapped around the insulation system 5.

The metal sheath consists of a copper material comprising at least 99 wt. % copper and at most 0.1 wt. % oxygen, or of a stainless steel which has a chromium equivalent in a range of 16-25 and a nickel equivalent in a range of 11-22 according to a Schaeffler-DeLong constitutional diagram for which the chromium equivalent is calculated according to the formula % Cr+% Mo+1.5×% Si+0.5×% Nb and the nickel equivalent is calculated according to the formula % Ni+0.5×% Mn+30×(% C+% N).

The metal sheath 12 may have a thickness in a range of 0.4-2 mm.

The copper material may comprise at most 0.06 wt. % oxygen, such as at most 0.05 wt. %, such as at most 0.04 wt. % oxygen, such as at most 0.004 wt. %, such as at most 0.001 wt. % oxygen.

The copper material may comprise at least 99.9 wt. % copper.

The copper material may for example be Cu-DHP, Cu-ETP, or Cu—OF.

A sample of the copper material may according to one example show no evidence of cracking after a hydrogen embrittlement test carried out according to section 8.2.2 of EN 1976, and EN ISO 2626.

The stainless steel may be an austenitic stainless steel type selected from one of type 304, 304L, 316, 316L, 316Ti, 316Cb 321, or 347 as defined by ASTM A240/A240M-22b or equivalents thereof according to EN 10088-1:2005.

In a step c) opposing edges 12a and 12b of the metal sheath 12 are welded longitudinally by autogenous welding to form the metallic water-blocking layer 13 around the insulation system 5. This process can be seen in FIG. 2, where a welding tool 21 autogenously welds the opposing edges 12a and 12b as the cable core including the conductor 3, the insulation system 5 and the metal sheath 12 arranged around the insulation system 5 are moved along a longitudinal axis of the cable core as shown by the arrow 23.

The opposing edges 12a and 12b are preferably aligned with each other in the same tangential plane of the metal sheath 12, when step c) is being performed.

The stainless steel may in the weld seam have a Ferrite Number in a range of 1-15 after the autogenous welding in step c) has been performed.

The autogenous welding may be one of laser, tungsten inert gas (TIG), or plasma autogenous welding. The welding tool 21 may thus be a laser autogenous welding tool, a TIG autogenous welding tool, or a plasma autogenous welding tool.

The welding in step c) is preferably performed using a protective shielding gas, e.g., a gas comprising more than 90% inert gas such as argon or helium, optionally mixed with a few percentages by weight of oxygen gas, carbon dioxide gas or hydrogen gas in case the metal sheath is made of a stainless steel. The welding in step c) is thus performed in an oxygen-free or at least essentially oxygen-free environment.

In step c) the opposing edges 12a and 12b of the metal sheath 12 subjected to welding are preferably arranged radially distanced from an outer surface of the outer semiconducting layer 11. The region of welding, and the developed heat, will thus be spaced apart from the insulation system 5.

After step c) the metallic water-blocking layer 13 may according to one example be subjected to a diameter reduction step. In this case a set of rollers pressed against the outer surface of the metallic water-blocking layer 13 reduce the diameter of the metallic water-blocking layer 13. Alternatively, a die may be used or combined with the set or rollers to reduce the diameter of the metallic water-blocking layer 13.

The submarine power cable 1 obtained by means of the method may be a dynamic submarine power cable or a static submarine power cable.

Static submarine power cables are typically much longer, and thus made in longer lengths, than dynamic submarine power cables. Step c) may be performed for a continuous length of the conductor 3 and the insulation system 5 which is at least 5 km, such as at least 10 km.

The inventive concept has mainly been described above with reference to a few examples. However, as is readily appreciated by a person skilled in the art, other embodiments than the ones disclosed above are equally possible within the scope of the inventive concept, as defined by the appended claims.

1. A method of manufacturing a submarine power cable (1), comprising:
a) providing an insulation system around a conductor, the insulation system including an inner semiconducting layer arranged around the conductor, an insulation layer arranged around the inner semiconducting layer, and an outer semiconducting layer arranged around the insulation layer,
b) arranging a metal sheath around the insulation system, and
c) welding opposing edges of the metal sheath longitudinally by autogenous welding to form a metallic water-blocking layer around the insulation system,
wherein the metal sheath consists of a copper material comprising having at least 99 wt. % copper and at most 0.1 wt. % oxygen, or
wherein the metal sheath consists of a stainless steel which has a chromium equivalent in a range of 16-25 and a nickel equivalent in a range of 11-22 according to a Schaeffler-DeLong constitutional diagram for which the chromium equivalent is calculated according to the formula % Cr+% Mo+1.5×% Si+0.5×% Nb and the nickel equivalent is calculated according to the formula % Ni+0.5×% Mn+30×(% C+% N).

2. The method as claimed in claim 1, wherein after step c) has been performed the stainless steel has a Ferrite Number in a range of 1-15 in the weld seam.

3. The method as claimed in claim 1, wherein step c) is performed using a protective shielding gas.

4. The method as claimed in claim 1, wherein the copper material comprises at most 0.06 wt. % oxygen, such as at most 0.05 wt. %, such as at most 0.04 wt. % oxygen, such as at most 0.004 wt. %, such as at most 0.001 wt. % oxygen.

5. The method as claimed in claim 1, wherein the copper material comprises at least 99.9 wt. % copper.

6. The method as claimed in claim 1,
wherein the copper material is Cu-DHP, Cu-ETP, or Cu—OF.

7. The method as claimed in claim 1, wherein a sample of the copper material shows no evidence of cracking after a hydrogen embrittlement test carried out according to section 8.2.2 of EN 1976, and EN ISO 2626.

8. The method as claimed in claim 1, wherein the stainless steel is an austenitic stainless steel type selected from one of type 304, 304L, 316, 316L, 316Ti, 316Cb 321, or 347 as defined by ASTM A240/A240M-22b or equivalents thereof according to EN 10088-1:2005.

9. The method as claimed in claim 1, wherein the autogenous welding is one of laser, tungsten inert gas, TIG, or plasma autogenous welding.

10. The method as claimed in claim 1, wherein the metal sheath has a thickness in a range of 0.4-2 mm.

11. The method as claimed in claim 1, wherein the submarine power cable is a dynamic submarine power cable.

12. The method as claimed in claim 1,
wherein the submarine power cable is a static submarine power cable.

13. The method as claimed in claim 12, wherein step c) is carried out while the conductor with the insulation system around it moves longitudinally, and wherein step c) is performed for a continuous length of the conductor and the insulation system which is at least 5 km, such as at least 10 km.

14. The method as claimed in claim 1, wherein the submarine power cable is a high voltage power cable.

15. A submarine power cable obtainable by a method of manufacturing a submarine power cable, comprising:
a) providing an insulation system around a conductor, the insulation system including an inner semiconducting layer arranged around the conductor, an insulation layer arranged around the inner semiconducting layer, and an outer semiconducting layer arranged around the insulation layer,
b) arranging a metal sheath around the insulation system, and
c) welding opposing edges of the metal sheath longitudinally by autogenous welding to form a metallic water-blocking layer around the insulation system,
wherein the metal sheath consists of a copper material having at least 99 wt. % copper and at most 0.1 wt. % oxygen, or
wherein the metal sheath consists of a stainless steel which has a chromium equivalent in a range of 16-25 and a nickel equivalent in a range of 11-22 according to a Schaeffler-DeLong constitutional diagram for which the chromium equivalent is calculated according to the formula % Cr+% Mo+1.5×% Si+0.5×% Nb and the nickel equivalent is calculated according to the formula % Ni+0.5×% Mn+30×(% C+% N).

16. The method as claimed in claim 2, wherein step c) is performed using a protective shielding gas.

17. The method as claimed in claim 2, wherein the copper material comprises at most 0.06 wt. % oxygen, such as at most 0.05 wt. %, such as at most 0.04 wt. % oxygen, such as at most 0.004 wt. %, such as at most 0.001 wt. % oxygen.

18. The method as claimed in claim 2, wherein the copper material comprises at least 99.9 wt. % copper.

19. The method as claimed in claim 2, wherein the copper material is Cu-DHP, Cu-ETP, or Cu—OF.

20. The method as claimed in claim 2, wherein a sample of the copper material shows no evidence of cracking after a hydrogen embrittlement test carried out according to section 8.2.2 of EN 1976, and EN ISO 2626.
